(19) United States
(12) Patent Application Publication
(10) Pub. No.: US 2019/0195094 A1
(43) Pub. Date: Jun. 27, 2019

(54) WRENCH ASSEMBLY FOR ADJUSTING RELATIVE POSITION BETWEEN MECHANICAL COMPONENTS IN A MECHANICAL SYSTEM

(71) Applicant: Timothy J. Smith, Loomis, CA (US)

(72) Inventor: Timothy J. Smith, Loomis, CA (US)

(21) Appl. No.: 16/227,718

(22) Filed: Dec. 20, 2018

Related U.S. Application Data
(60) Provisional application No. 62/609,853, filed on Dec. 22, 2017.

(51) Int. Cl. F01L 1/20; B25B 13/48; B25B 23/142; B25B 23/00

(52) U.S. Cl. CPC F01L 1/20; B25B 13/48; F01L 2103/01; B25B 23/0007; B25B 23/1427

(57) ABSTRACT

A wrench assembly for use in adjusting relative position between a first mechanical component and a second mechanical component in a mechanical system includes a lash adjuster, a lash indicator, and a measurement scale. The lash adjuster includes an adjuster axis. Additionally, the lash adjuster is configured to selectively rotate about the adjuster axis to adjust the relative position between the first mechanical component and the second mechanical component. Further, a relative position between the lash indicator and the measurement scale provides a precise visual indication of the relative position between the first mechanical component and the second mechanical component. One of the lash indicator and the measurement scale is fixedly secured to the lash adjuster such that rotation of the lash adjuster about the adjuster axis provides a corresponding rotation of the one of the lash indicator and the measurement scale about the adjuster axis. The other of the lash indicator and the measurement scale does not rotate about the adjuster axis correspondingly with the lash adjuster.

### RELATED APPLICATION

This application claims priority on U.S. Provisional Application Ser. No. 62/609,853, filed on Dec. 22, 2017, and entitled “WRENCH ASSEMBLY FOR ADJUSTING SPACES IN MECHANICAL SYSTEMS THAT USE ADJUSTER SCREW AND ADJUSTER NUT”. As far as permitted, the contents of U.S. Provisional Application Ser. No. 62/609,853 are incorporated in their entirety herein by reference.

### BACKGROUND

Modern internal combustion engines typically include a plurality of cylinders, with each cylinder being generally equipped with one or more valves that are cyclically opened and closed during normal operation to control the introduction of fuel to the cylinders and the exhaustion of the product of combustion from the cylinders. The valves may be opened by way of an actuator assembly that includes a driving member, such as a camshaft, and a rocker arm. In particular, the camshaft actuates a valve lifter which in turn actuates the valve usually through a push rod and the rocker arm acting on the valve stem. The rocker arm extends between a tip of the valve stem and an end of the push rod. Additionally, the rocker arm can be manufactured to have any suitable or desired rocker ratio.

Because of expansion of internal combustion engine parts from heat generated during engine operation, it is common to provide an amount of valve lash, i.e. clearance or spacing, between the tip of the valve stem and a tip of the rocker arm which it contacts. Without such valve lash, the expanded parts might be severely stressed and subjected to possible ultimate failure. Thus, the plurality of valves can require various adjustments, e.g., valve lash adjustments, over time to ensure better performance. However, proper valve lash adjustment can be a delicate balancing act between durability and maximum power.

In many engine arrangements, the rocker arm can include a combination of an adjuster screw and an adjuster nut to adjust the spacing between the push rod and the adjuster screw, which in turn determines the amount of valve lash between the tip of the valve and the tip of the rocker arm that opens the valve. Thus, in such arrangements, it is desirable to mechanically adjust the adjuster screw and the adjuster nut on each valve with a wrench assembly, known in the industry as a valve lash adjuster, to obtain more efficient fuel burning and appropriate pressure in the cylinders of the engine.

Conventional valve lash adjusters have been used for decades. Unfortunately, these conventional valve lash adjusters have not been altogether satisfactory. Thus, it is desired to provide an improved wrench assembly, i.e. a valve lash adjuster, for precisely and efficiently adjusting the valve lash within the cylinders of the engine.

### SUMMARY

The present invention is directed toward a wrench assembly for use in adjusting relative position between a first mechanical component and a second mechanical component in a mechanical system. In various embodiments, the wrench assembly includes a lash adjuster, a lash indicator, and a measurement scale. The lash adjuster includes an adjuster axis. Additionally, the lash adjuster is configured to selectively rotate about the adjuster axis to adjust the relative position between the first mechanical component and the second mechanical component. Further, a relative position between the lash indicator and the measurement scale provides a precise visual indication of the relative position between the first mechanical component and the second mechanical component.

In some embodiments, one of the lash indicator and the measurement scale is fixedly secured to the lash adjuster such that rotation of the lash adjuster about the adjuster axis provides a corresponding rotation of the one of the lash indicator and the measurement scale about the adjuster axis. In such embodiments, the other of the lash indicator and the measurement scale does not rotate about the adjuster axis correspondingly with the lash adjuster. For example, in one embodiment, the lash indicator is fixedly secured to the lash adjuster and rotates about the adjuster axis correspondingly with the rotation of the lash adjuster. Alternatively, in another embodiment, the measurement scale is fixedly secured to the lash adjuster and rotates about the adjuster axis correspondingly with the rotation of the lash adjuster.

In certain embodiments, the lash indicator points at the measurement scale to provide the visual indication of the relative position between the first mechanical component and the second mechanical component. Additionally, in one such embodiment, the measurement scale includes a plurality of measurement markers that are incrementally spaced apart from one another on a face of the measurement scale.

Additionally, in some applications, the mechanical system includes an adjuster screw. In such applications, the lash adjuster is configured to engage the adjuster screw and rotate the adjuster screw to adjust the relative position between the first mechanical component and the second mechanical component. Further, the adjuster screw can have a thread pitch. Additionally, the first mechanical component can be a rocker arm having a rocker ratio. In such embodiment, the measurement scale can be rotatable about the adjuster axis to calibrate the relationship between the lash indicator and the measurement scale based at least in part on the thread pitch of the adjuster screw and the rocker ratio of the rocker arm. In certain such embodiments, the wrench assembly can further include a torque wrench head and a base member that is fixed secured to the torque wrench head. In such embodiments, the base member is configured to center the lash adjuster for accurate engagement with the adjuster screw. Still further, in some such applications, the mechanical system further includes an adjuster nut that is selectively rotatable relative to the adjuster screw. In such applications, the wrench assembly further includes a socket that is selectively positionable about the adjuster nut, the socket including a socket axis, the socket being selectively rotatable about the socket axis to adjust the position of the adjuster nut relative to the adjuster screw to adjust a torque setting within the mechanical system.

Additionally, the present invention is also directed toward a method for using a wrench assembly for adjusting relative position between a first mechanical component and a second mechanical component in a mechanical system, the method including (i) selectively rotating a lash adjuster about an adjuster axis to adjust the relative position between the first mechanical component and the second mechanical component; (ii) providing a lash indicator; (iii) providing a measurement scale; and (iv) fixedly securing one of the lash indicator and the measurement scale to the lash adjuster such that rotation of the lash adjuster about the adjuster axis provides a corresponding rotation of the one of the lash indicator and the measurement scale about the adjuster axis; and wherein a relative position between the lash indicator and the measurement scale provides a precise visual indication of the relative position between the first mechanical component and the second mechanical component.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a partially exploded side view illustration of a portion of a mechanical system including a first mechanical component and a second mechanical component, and an embodiment of a wrench assembly having features of the present invention that is configured to adjust a relative position between the first mechanical component and the second mechanical component within the mechanical system;

FIG. 1B is a partially exploded perspective view illustration of the wrench assembly illustrated in FIG. 1A;

FIG. 1C is an exploded perspective view illustration of the wrench assembly illustrated in FIG. 1A;

FIG. 2 is an exploded perspective view illustration of another embodiment of the wrench assembly; and

FIG. 3 is a flowchart illustrating one representative example of a use of the wrench assembly.

### DESCRIPTION

Embodiments of the present invention are described herein in the context of a wrench assembly for adjusting relative position, e.g., spacing, clearance or lash, between a first mechanical component and a second mechanical component in a mechanical system. More specifically, in some embodiments, the wrench assembly of the present invention includes a lash adjuster that is configured to more accurately and precisely adjust spaces in mechanical systems that use an adjuster screw, an adjuster nut and/or a rocker arm.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

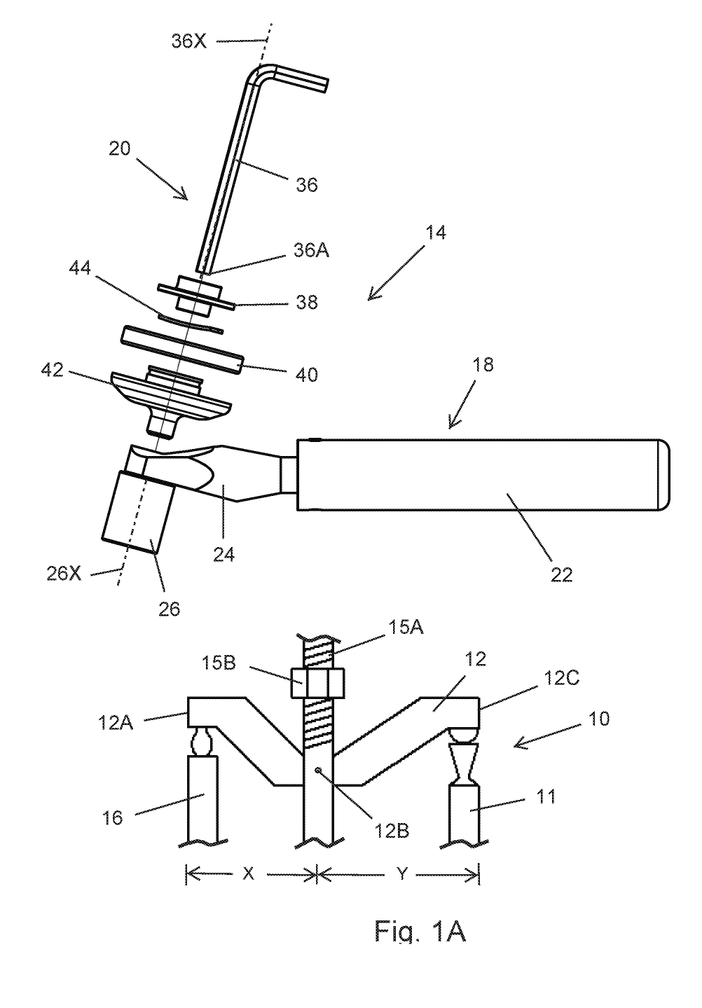

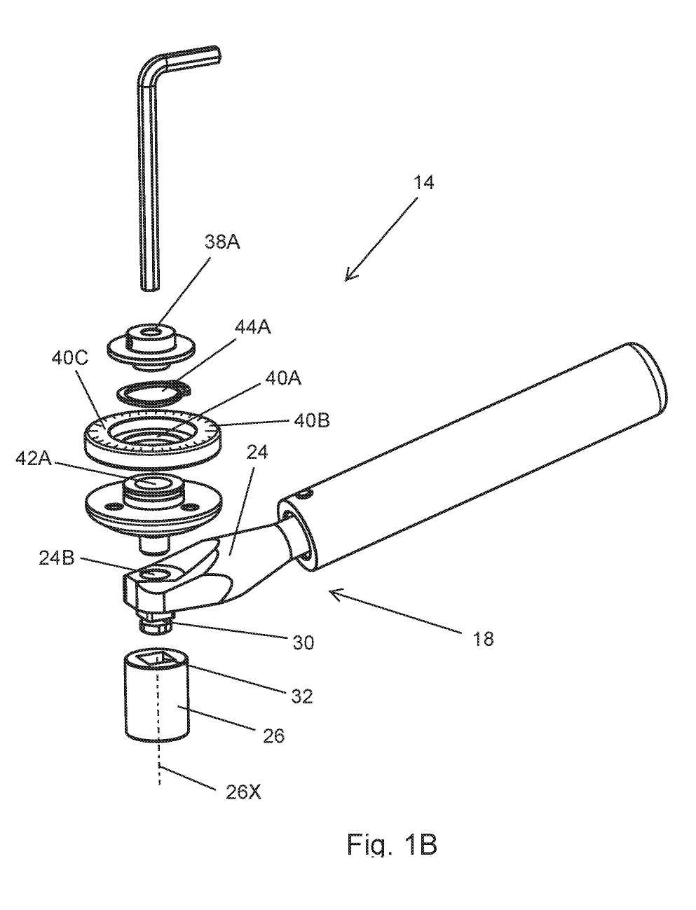

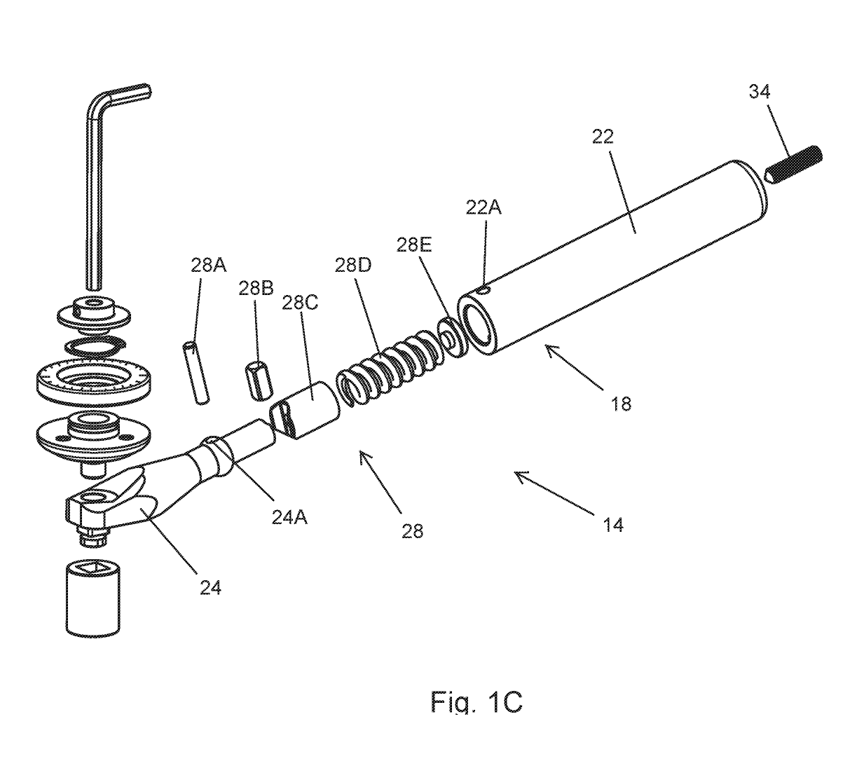

FIG. 1A is a partially exploded side view illustration of a portion of a mechanical system 10 including a first mechanical component 11 and a second mechanical component 12, and an embodiment of a wrench assembly 14 having features of the present invention that is configured to adjust relative position, i.e. the lash or spacing, between the first mechanical component 11 and the second mechanical component 12 within the mechanical system 10. Additionally, FIG. 1B is a partially exploded perspective view illustration of the wrench assembly 14 illustrated in FIG. 1A, which illustrates certain additional features and components of the wrench assembly 14. Further, FIG. 1C is an exploded perspective view illustration of the wrench assembly 14 illustrated in FIG. 1A, which also illustrates certain additional features and components of the wrench assembly 14.

As provided herein, the wrench assembly 14 can be configured for use with any suitable type of mechanical system 10. For example, in various non-exclusive embodiments, the wrench assembly 14 can be used with engines for automobiles or other machines, such as those used in high performance racing, motorcycles and/or other types of motorized vehicles. In such embodiments, the mechanical system 10 can include a cylinder of an internal combustion engine, and the first mechanical component 11 can be a valve and the second mechanical component 12 can be a rocker arm with any suitable or desired rocker ratio. Additionally, in such embodiments, the wrench assembly 14 can be configured to adjust the relative position, i.e. the lash or spacing, between a tip of the valve and a tip of the rocker arm that opens the valve. Alternatively, the wrench assembly 14 can be used for numerous other purposes that require adjustment of multiple mechanical components of the mechanical system 10.

In one non-exclusive embodiment, as shown in FIG. 1A, the mechanical system 10 can include a stud-mounted rocker. Alternatively, in another non-exclusive embodiment, the mechanical system 10 can include a shaft-mounted rocker. Still alternatively, in other embodiments, the mechanical system 10 can include other components and/or have another suitable design.

Further, in various embodiments, as described in detail herein, the wrench assembly 14 is most appropriate for adjusting lash in mechanical systems 10 that use an adjuster screw 15A and an adjuster nut 15B. It is understood that the terms adjuster screw 15A and adjuster nut 15B can include any suitable form and/or combination that may be used in mechanical systems requiring adjustment, including screws, bolts, pins, nuts, etc. As referenced herein, the adjuster nut 15B generally threads onto the adjuster screw 15A. In other words, the adjuster screw 15A rotates upon a thread pitch inside the adjuster nut 15B. In certain embodiments, the adjuster screw 15A is generally connected to a part and/or structure, e.g., to one of the mechanical components 11, 12, of the mechanical system 10, such that the adjuster nut 15B and the adjuster screw 15A combination can adjust the lash of the specific part and/or structure relative to another part and/or structure of the mechanical system 10. For example, in an embodiment such as noted above, the mechanical system 10 may include the rocker arm 12, wherein the rocker arm 12 includes the adjuster nut 15B and adjuster screw 15A combination to adjust the lash between a push rod 16 and the adjuster screw 15A. The adjustment of the lash between the push rod 16 and the adjuster screw 15A in turn determines the amount of lash between a tip of the valve 11 and a tip of the rocker arm 12 that opens the valve 11. In various applications, the appropriate or desired spacing or lash between the first mechanical component 11 and the second mechanical component 12 can be precisely determined and controlled based at least in part on the thread pitch of the adjuster screw 15A and the rocker ratio of the rocker arm 12.

FIG. 1A further illustrates the calculation or determination of the rocker ratio of the rocker arm 12. In particular, a length of the push rod side of the rocker arm 12 from a first end 12A of the rocker arm 12 to a pivot point 12B of the rocker arm 12 is shown as “X” in FIG. 1A. Additionally, a length of the valve side of the rocker arm 12 from a second end 12C of the rocker arm 12 to the pivot point 12B of the rocker arm 12 is shown as “Y” in FIG. 1A. From these values, the rocker ratio is defined as the ratio of Y:X. In some embodiments, the rocker ratio of the rocker arm 12 can be between approximately 1.25:1 and 1.75:1. In other embodiments, the rocker ratio of the rocker arm 12 can be between approximately 1.4:1 and 1.6:1. Still alternatively, the rocker ratio of the rocker arm 12 can be another suitable value that is outside of the ranges specifically identified herein.

It is appreciated that although the valve and the rocker arm are identified herein as specific examples of the first mechanical component 11 and the second mechanical component 12, respectively, such relationship is not intended to be limiting in any manner. For example, it is appreciated that any of the valve, the rocker arm, the push rod 16, the adjuster screw 15A and the adjuster nut 15B can be referred to as the “first mechanical component” and/or the “second mechanical component”, as described herein.

As an overview, it is appreciated that in such applications, the relationship between the adjuster nut 15B and the adjuster screw 15A, including the thread pitch of the adjuster screw 15A, at a specified torque setting, as well as the rocker ratio, ultimately determines the valve lash on the rocker arm 12. As provided herein, with the present invention, the wrench assembly 14 is uniquely configured to precisely and accurately indicate the relative position between the first mechanical component 11, e.g., the tip of the valve, and the second mechanical component 12, e.g., the tip of the rocker arm, thus enabling the user to precisely adjust the relative positions of the mechanical components 11, 12, e.g., the valve lash, without guessing.

The design of the wrench assembly 14 can be varied. In various embodiments, as shown in FIG. 1A, the wrench assembly 14 can include a torque adjustment assembly 18 for selectively adjusting a desired torque specification (also sometimes referred to herein as a “torque setting”) within the mechanical system 10, and a lash adjustment assembly 20 for selectively adjusting the relative position, or lash, between the mechanical components 11, 12 of the mechanical system 10. It is appreciated that in many embodiments, the components used within and the functioning of the torque adjustment assembly 18 and the lash adjustment assembly 20 can overlap and/or be interrelated with one another. Additionally, it is appreciated that each of the torque adjustment assembly 18 and the lash adjustment assembly 20 can include more components or fewer components than those specifically illustrated and described herein.

It is further appreciated that lash adjustments do change depending on the amount of torque applied to the adjuster nut 15B and adjuster screw 15A combination. Thus, as provided herein, by torqueing the adjuster nut 15B to the correct torque specification, e.g., with the torque adjustment assembly 18, each time prior to checking and adjusting as necessary the valve lash, it is easier to precisely make the required adjustment to the valve lash, e.g., with the lash adjustment assembly 20, the first time. Otherwise, the user would have to go back after any lash adjustments and torque the adjuster nut 15B properly, and then re-check the lash adjustment.

In certain embodiments, as noted above, the wrench assembly 14, via the torque adjustment assembly 18, can be configured to be set to varying torque specifications, or torque settings. It is appreciated that the wrench assembly 14 can include any torque settings that the adjuster nut 15B and adjuster screw 15A combination may require. Additionally, it is further appreciated that the torque settings can be provided in any suitable units, such as foot-pounds, inch-pounds, newton-meters, or any other suitable units.

The design of the torque adjustment assembly 18 can be varied to provide the necessary and desired adjustments to the torque settings. As shown in FIG. 1A, the torque adjustment assembly 18 can include a torque wrench body 22, a torque wrench head 24, and a socket 26 that is selectively coupled to the torque wrench head 24.

As illustrated, the torque wrench head 24 is coupled to the torque wrench body 22. In some embodiments, the torque adjustment assembly 18 can include a coupling assembly 28 (illustrated in FIG. 1C) for purposes of coupling the torque wrench head 24 to the torque wrench body 22, such that movement of the torque wrench body 22 results in corresponding movement and control of the torque wrench head 24.

Additionally, as shown, the socket 26 is selectively coupled to the torque wrench head 24. In various embodiments, a socket receiver 30 (illustrated in FIG. 1B) can be utilized to selectively couple the socket 26 to the torque wrench head 24, such that movement, e.g., rotation, of the torque wrench head 24 results in corresponding and/or related movement, e.g., rotation, of the socket 26.

As provided herein, the torque adjustment assembly 18 can be used to adjust the position of the adjuster nut 15B, e.g., relative to the adjuster screw 15A. More particularly, in certain embodiments, the socket 26 can include a nut engager (not shown) that can be positioned to fit around and/or engage the adjuster nut 15B. The nut engager can be four-, five-, six-, eight- or twelve-sided (as non-exclusive examples), in order to fit over and/or engage the adjuster nut 15B to be adjusted. The socket 26 can then be rotated about a socket axis 26X to adjust the position of the adjuster nut 15B relative to the adjuster screw 15A and/or relative to the rocker arm 12, which position adjustment can vary depending upon the particular rocker ratio of the rocker arm 12. For example, rotation of the socket 26 about the socket axis 26X in a first direction can move the adjuster nut 15B so as to tighten the adjuster nut 15B down toward and/or against the rocker arm 12. Additionally, rotation of the socket 26 about the socket axis 26X in an opposite, second direction can move the adjuster nut 15B away from the rocker arm 12 and, thus, loosens the adjuster nut 15B relative to the rocker arm 12.

Referring now to FIG. 1B, as noted, the socket receiver 30 is utilized to selectively couple the socket 26 to the torque wrench head 24. For example, in some embodiments, the socket 26 can include a wrench engager 32 that is opposite the nut engager, and the socket receiver 30 can be configured to selectively engage the wrench engager 32. Stated in another manner, the socket receiver 30 is used to selectively receive and retain the socket 26 via engagement between the socket receiver 30 and the wrench engager 32. In one embodiment, the socket 26 can be a standard socket having a four-sided wrench engager 32 that engages the socket receiver 30. Alternatively, the socket 26 can have a wrench engager 32 that has greater than four sides or fewer than four sides for engagement with the socket receiver 30.

The socket receiver 30 can be configured to have any suitable width dimensions, i.e. ¼ inch, ⅜ inch, ½ inch, etc., as non-exclusive examples, in order to effectively and selectively receive and retain the socket 26, i.e. via engagement with the wrench engager 32. However, it is recognized that the width dimensions of the socket receiver 30 can be larger or smaller than the foregoing examples.

Additionally, it is appreciated that the socket receiver 30 can be configured to engage sockets 26 of various different sizes. Stated in another manner, in various embodiments, the socket 26 is removable and can be replaced with a different sized socket 26 depending on the specific requirements of use of the wrench assembly 14, i.e. depending on the specific dimensions of the components of the mechanical system 10. In such embodiments, the socket receiver 30 of the torque adjustment assembly 18 and the wrench engager 32 of the socket 26 can be sized and shaped so as to allow a more universal type connection between the socket receiver 30 and sockets 26 of various different sizes.

In certain embodiments, the socket receiver 30 can include a bearing element, which can be used to exert a rotational force (torque) on the socket 26 in order to tighten or loosen the adjuster nut 15B as desired. Additionally, the socket receiver 30 can be further configured to inhibit any unwanted movement of the socket 26 in a direction substantially along the socket axis 26X. For example, in some embodiments, the socket receiver 30 includes a resilient material, such as a rubberized O-ring in one non-exclusive embodiment, which selectively retains the socket 26 and inhibits the socket 26 from becoming disengaged from the socket receiver 30. Stated in another manner, with such design, the socket receiver 30 is configured to inhibit movement of the socket 26 in a direction along the socket axis 26X (illustrated in FIG. 1A). The O-ring can alternatively be formed from another suitable material, such as plastic, acrylic, metal, silicon, other synthetic materials, etc. Alternatively, the socket receiver 30 can utilize another suitable mechanism for retaining the socket 26.

In some embodiments, the socket receiver 30 is integrally formed with the torque wrench head 24. Alternatively, the socket receiver 30 can be formed separately from the torque wrench head 24 and then subsequently be secured to the torque wrench head 24 by any suitable means.

Additionally, in certain embodiments, the socket receiver 30 can be fixed relative to the torque wrench head 24 such that the socket receiver 30 rotates in either direction with the rotation of the torque wrench head 24. Alternatively, in other embodiments, the socket receiver 30 can include a ratchet mechanism, such that the socket receiver 30 can rotate relative to the torque wrench head 24 in a ratcheting manner.

Referring now to FIG. 1C, a non-exclusive example of the coupling assembly 28 is illustrated, which is configured to couple the torque wrench head 24 to the torque wrench body 22 so as to enable and control any desired torque adjustments. In this embodiment, the coupling assembly 28 can include one or more of a dowel pin 28A, a click ball 28B, a V-block 28C, a tension spring 28D and a spring seat 28E that cooperate to enable the desired coupling between the torque wrench head 24 and the torque wrench body 22. As shown, the dowel pin 28A can be configured to fit within and/or extend through a body aperture 22A in the torque wrench body 22 and a head aperture 24A in the torque wrench head 24 for purposes of providing the desired physical coupling between the torque wrench head 24 and the torque wrench body 22. Additionally, the other components of the coupling assembly 28, i.e. the click ball 28B, the V-block 28C, the tension spring 28D and the spring seat 28E, enable the desired control of the torque adjustment assembly 18.

Also shown in FIG. 1C is a torque adjustment screw 34 that is configured for selectively adjusting and/or controlling the desired torque setting.

Alternatively, the coupling assembly 28 can have another suitable design. For example, in one non-exclusive alternative embodiment, the desired coupling, adjusting and controlling performed with the coupling assembly 28 can be achieved with an electronic load cell combined with mechanical attachments in order to produce the desired torque.

Referring again back to FIG. 1A, the lash adjustment assembly 20 will now be described in greater detail. The design of the lash adjustment assembly 20 can be varied. In certain embodiments, as shown in FIG. 1A, the lash adjustment assembly 20 includes a lash adjuster 36 (also sometimes referred to as a “fastener”), a lash indicator 38 (also sometimes referred to as a “pointer”), a measurement scale 40 (also sometimes referred to as a “dial”), a base member 42, and a retaining member 44. Alternatively, the lash adjustment assembly 20 can include more components or fewer components than those listed herein.

As provided herein, in this embodiment, the lash adjuster 36 is configured to engage the adjuster screw 15A to adjust the lash between the push rod 16 and the adjuster screw 15A, which in turn, based at least in part on the rocker ratio, determines the lash between the tip of the valve 11 and the tip of the rocker arm 12 that opens the valve 11. More specifically, the lash adjuster 36 includes an adjuster end 36A that is positioned to engage a screw end (not shown) of the adjuster screw 15A. Additionally, in this embodiment, the lash adjuster 36 is further positioned to extend through each of the lash indicator 38, the measurement scale 40, the base member 42 and the retaining member 44. In particular, the lash adjuster 36 is positioned to extend through an indicator aperture 38A (illustrated in FIG. 1B) of the lash indicator 38, through a scale aperture 40A (illustrated in FIG. 1B) of the measurement scale 40, through a base aperture 42A (illustrated in FIG. 1B) of the base member 42, and through a retainer aperture 44A (illustrated in FIG. 1B) of the retaining member 44. Further, the lash adjuster 36 is further positioned to extend through a receiver aperture 24B (illustrated in FIG. 1B) of the torque wrench head 24, and through the wrench engager 32 (illustrated in FIG. 1B) of the socket 26.

It is appreciated that the lash adjuster 36 need not only be configured to engage the adjuster screw 15A, and the lash adjuster 36 can additionally or alternatively be configured to engage any other suitable part to be adjusted.

The lash adjuster 36 can have any suitable design for purposes of effectively engaging the screw end of the adjuster screw 15A so as to rotate the adjuster screw 15A. Stated in another manner, the size and shape of the lash adjuster 36 can be varied to accommodate various sizes and shapes of adjuster screws 15A depending on the manufacturer and the application. For example, in one embodiment, as shown in FIG. 1A, the lash adjuster 36 can be a hex key that is configured to engage a substantially hexagon-shaped recess in the screw end of the adjuster screw 15A. Alternatively, the lash adjuster 36 can have another suitable design. For example, in other non-exclusive alternative embodiments, the lash adjuster 36 can be a slotted screwdriver or screwdriver bit, and/or can have an “X” configuration, a star configuration, or any other suitable shape.

During use of the lash adjustment assembly 20, the lash adjuster 36 is rotated about an adjuster axis 36X to loosen, tighten or otherwise position the adjuster screw 15A (or other suitable part) as necessary to achieve the desired lash and/or relative positioning of the part. As shown in FIG. 1A, in certain embodiments, the adjuster axis 36X can be substantially coaxial with the socket axis 26X.

The lash indicator 38, or pointer, can be utilized as a visual indicator of the direction and extent of rotation of the lash adjuster 36, and thus the adjuster screw 15A, in relationship to the measurement scale 40. In this embodiment, the lash indicator 38 is fixedly secured to the lash adjuster 36 so as to rotate with the lash adjuster 36 about the adjuster axis 36X. Additionally, in certain embodiments, the measurement scale 40 can include measurement markers 40B (illustrated in FIG. 1B) that are positioned on a face 40C (illustrated in FIG. 1B) of the measurement scale 40. During rotation of the lash adjuster 36, and thus the lash indicator 38, the lash indicator 38 will point toward the measurement markers 40B on the face 40C of the measurement scale 40 to visually indicate the direction and rotation of the adjuster screw 15A, and thus the precise adjustment of the lash, e.g., between the first mechanical component 11 and the second mechanical component 12. Alternatively, in one embodiment, the lash adjustment assembly 20 can be designed without a separate lash indicator 38, and the lash adjuster 36 can be integrally formed with the lash indicator to further serve the purpose of providing a visual indication of the direction and rotation of the adjuster screw 15A, and thus the precise adjustment of the lash, e.g., between the first mechanical component 11 and the second mechanical component 12.

As shown, the measurement markers 40B can be incrementally positioned about the face 40C of the measurement scale 40 to enable precise lash adjustment with the lash adjustment assembly 20. In one embodiment, the measurement markers 40B, or measurement increments, can include degrees. In such embodiment, the degreed measurement increments 40B can cover a full three hundred sixty degrees around the face 40C of the measurement scale 40, or dial. In other embodiments, the face 40C of the dial 40 can include degreed increments covering any portion of three hundred sixty degrees. In still other embodiments, the face 40C of the dial 40 can include any other suitable measurement increments, degreed or otherwise, that may be used with the adjuster nut 15B and adjuster screw 15A combination. For example, the measurement markers 40B can be provided at increments of 0.005 inches, 0.001 inches, or 0.0005 inches, as certain non-exclusive examples.

Additionally, in one embodiment, the measurement scale 40 can be mounted to the base member 42, and can be allowed to rotate about the adjuster axis 36X precisely in order to calibrate or to zero the relationship of the lash indicator 38 to the measurement scale 40. It is appreciated that the calibration between the lash indicator 38 and the measurement scale 40 can include calibration to any thread pitch of the adjuster screw 15A, as well as calibration to any rocker ratio of the rocker arm 12. Additionally, it is further appreciated that in certain embodiments, the calibration of the measurement scale 40 to the thread pitch of the adjuster screw 15A and the rocker ratio of the rocker arm 12 can entail the use of different precisely calibrated measurement scales 40 that can be alternatively mounted relative to the lash adjuster 36, the lash indicator 38 and/or the base member 42. Stated in another manner, in such embodiments, the specific measurement scale 40 used at any given time with the wrench assembly 14 is selected based on the thread pitch of the adjuster screw 15A and the rocker ratio of the rocker arm 12 with which the wrench assembly 14 will be used.

In certain embodiments, the base member 42 is configured to be positioned tightly against the torque wrench head 24. Additionally, the base member 42 can be further configured to be stationary, i.e. fixed in its position relative to the torque wrench head 24, during use of the wrench assembly 14. The base member 42 is generally utilized for two separate purposes. First, the base member 42 can be used to center and allow for the measurement scale 40 to accurately rotate about the adjuster axis 36X. Second, the base member 42 also allows for the lash adjuster 36 to be properly centered for accurate insertion into and/or engagement with the adjuster screw 15A.

The retaining member 44 can have any suitable design for purposes of maintaining the desired positioning of certain components of the lash adjustment assembly 20. For example, in one embodiment, the retaining member 44 can be a retention clip that holds the measurement scale 40 to the fixed base member 42 at a proper tension so as to allow for desired and precise rotation and calibration of the measurement scale 40 about the adjuster axis 36X.

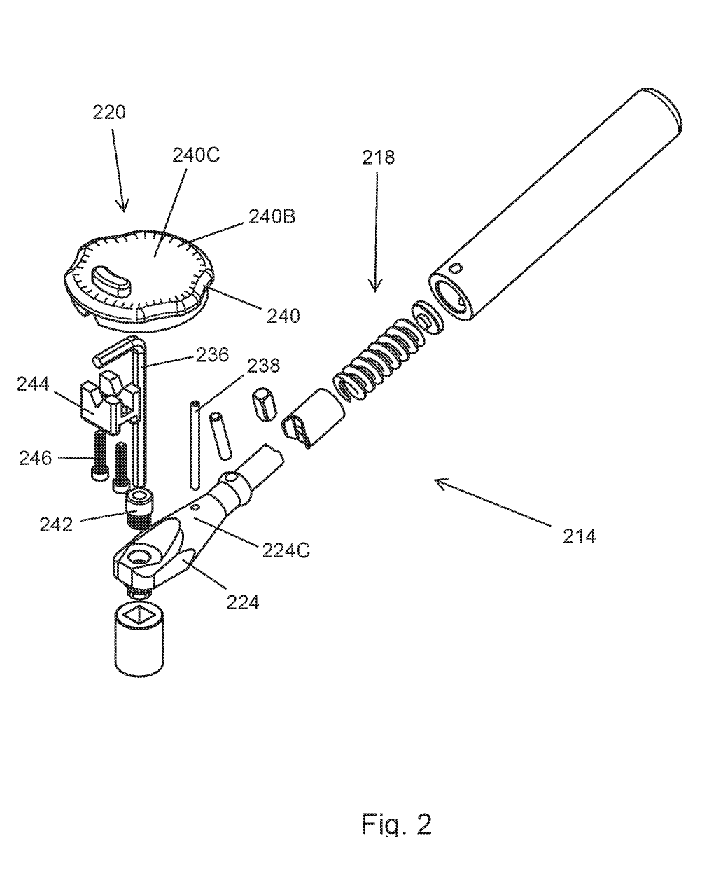

FIG. 2 is an exploded perspective view illustration of another embodiment of the wrench assembly 214. As illustrated in this embodiment, the wrench assembly 214 again includes a torque adjustment assembly 218 and a lash adjustment assembly 220. Additionally, as shown in FIG. 2, the torque adjustment assembly 218 is substantially similar to the torque adjustment assembly 18 illustrated and described above. Accordingly, the various components and details thereof of the torque adjustment assembly 218 will not be described in detail herein.

However, in this embodiment, the lash adjustment assembly 220 is somewhat different than in the previous embodiment. As shown in FIG. 2, in this embodiment, the lash adjustment assembly 220 includes a lash adjuster 236, a lash indicator 238, a measurement scale 240, a base member 242, a retaining member 244, and one or more attachers 246. Alternatively, the lash adjustment assembly 220 can include more components or fewer components than what is specifically shown in FIG. 2.

It is appreciated that although this embodiment of the lash adjustment assembly 220 and the previous embodiment of the lash adjustment assembly 20 have certain components in common, in some instances the components are positioned and/or function somewhat differently than in the previous embodiment. For example, in the embodiment of the lash adjustment assembly 20 illustrated and described in relation to FIG. 1A, the lash indicator 38, or pointer, is fixedly secured to and rotates with the lash adjuster 36, while the measurement scale 40, or dial, does not rotate with the lash adjuster 36. However, in this embodiment, the measurement scale 240, or dial, is fixedly secured to and rotates with the lash adjuster 236, while the lash indicator 238, or pointer, does not rotate with the lash adjuster 236. It is appreciated than in either embodiment, it is the relative movement and/or position between the lash indicator 38, 238 and the measurement scale 40, 240, e.g., during rotation of the lash adjuster 36, 236, that enables the precise and accurate lash adjustments between the mechanical components 11, 12 (illustrated in FIG. 1A) of the mechanical system 10 (illustrated in FIG. 1A), and/or the precise adjustment of the adjuster screw 15A (illustrated in FIG. 1A) relative to the adjuster nut 15B and/or the other components of the mechanical system 10. Stated in another manner, a relative position between the lash indicator 38 and the measurement scale 40 provides a precise visual indication of the relative position between the first mechanical component 11 and the second mechanical component 12. As noted above, it is appreciated that the first mechanical component 11 and the second mechanical component 12 can be any components of the mechanical system 10, e.g., the valve, the rocker arm, the push rod 16, the adjuster screw 15A, the adjuster nut 15B, etc. Additionally, it is further noted that a rocker ratio of greater than one, i.e. when the pivot point 12B (illustrated in FIG. 1A) of the rocker arm is not positioned centrally along the rocker arm, generates more lift for the valve by multiplying the lift from the push rod 16 (illustrated in FIG. 1A) by the rocker ratio of the rocker arm.

As shown in FIG. 2, the lash adjuster 236 can again have any suitable configuration for purposes of engaging the adjuster screw 15A to adjust the lash between the push rod 16 (illustrated in FIG. 1A) and the adjuster screw 15A, which in turn determines the lash between the tip of the valve 11 and the tip of the rocker arm 12 that opens the valve 11. For example, in one embodiment, as shown in FIG. 2, the lash adjuster 236 can be a hex key that is configured to engage a substantially hexagon-shaped recess in the screw end of the adjuster screw 15A. Alternatively, the lash adjuster 236 can have another suitable design. For example, in other non-exclusive alternative embodiments, the lash adjuster 236 can be a slotted screwdriver or screwdriver bit, and/or can have an “X” configuration, a star configuration, or any other suitable shape. It is further appreciated that the size and shape of the lash adjuster 236 can be varied to accommodate various sizes and shapes of adjuster screws 15A depending on the manufacturer and the application.

As with the previous embodiment, the lash indicator 238, or pointer, can again be utilized as a visual indicator of the direction and extent of rotation of the lash adjuster 236, and thus the adjuster screw 15A, in relationship to the measurement scale 240. However, in this embodiment, the lash indictor 238 is fixed to the torque wrench head 224. For example, in one non-exclusive embodiment, the lash indicator 238 is substantially cylindrical, dowel-shaped, and is fixedly secured to and extends away from a surface 224C, e.g., an upper surface, of the torque wrench head 224. With such design, as noted above, the lash indicator 238 does not rotate in connection with the rotation of the lash adjuster 236.

In the embodiment shown in FIG. 2, the measurement scale 240 is precisely mounted to the lash adjuster 236, e.g., with the retaining member 244 and the one or more attachers 246, so that the measurement scale 240 rotates correspondingly with the rotation of the lash adjuster 236, and thus the adjuster screw 15A. Additionally, the measurement scale 240 can again include measurement markers 240B that are incrementally spaced on a face 240C of the measurement scale 240. The measurement markers 240B can again be configured to indicate any suitable measurement increments, degreed or otherwise, that may be used with the adjuster nut 15B and adjuster screw 15A combination, and the rocker arm with various rocker ratios.

During rotation of the lash adjuster 236, and thus the measurement scale 240, the fixed lash indicator 238 will point toward the measurement markers 240B on the face 240C of the measurement scale 240 to visually indicate the direction and rotation of the adjuster screw 15A, and thus the precise adjustment of the lash, e.g., between the first mechanical component 11 and the second mechanical component 12.

In certain embodiments, the base member 242 is configured to be positioned tightly against the torque wrench head 224. Additionally, the base member 242 can be further configured to be stationary, i.e. fixed in its position relative to the torque wrench head 224, during use of the wrench assembly 214. Further, in the embodiment illustrated in FIG. 2, the base member 242 generally serves the sole purpose to center the lash adjuster 236 for proper insertion into and/or engagement with the adjuster screw 15A.

Additionally, as shown in FIG. 2, the retaining member 244 can be provided in the form of a specialized jaw that will accept and attach various sized lash adjusters 236 to the measurement scale 240, so as to maintain precision orientation of the lash adjuster 236 to the measurement scale 240. Further, the one or more attachers 246, e.g., screws, can be utilized to fix the retaining member 244 to the measurement scale 240, with a portion of the lash adjuster 236 held in place therebetween.

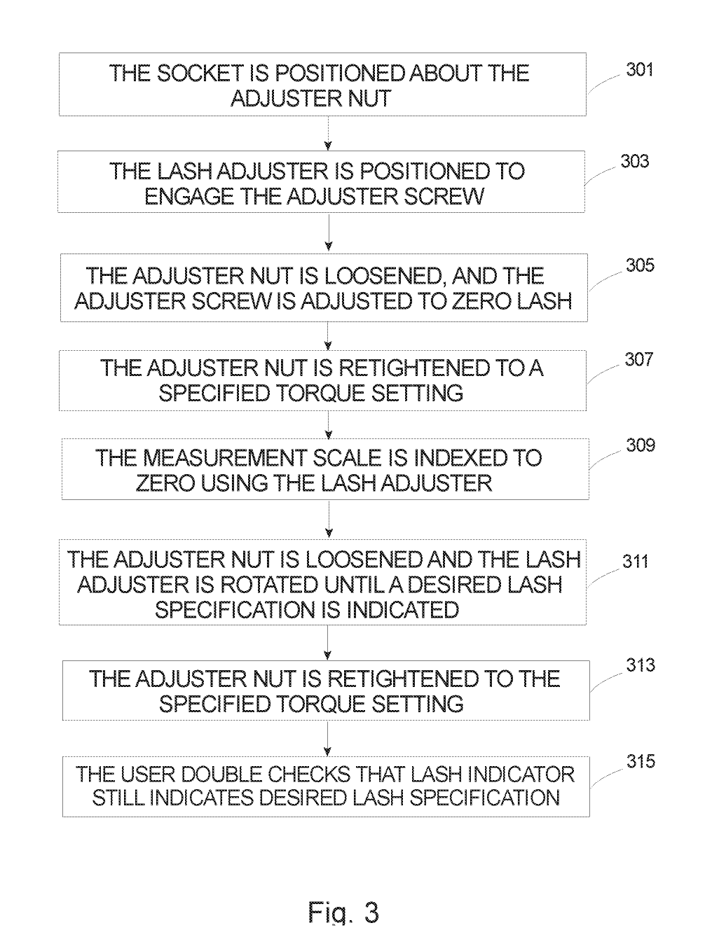

FIG. 3 is a flowchart illustrating one representative example of a use and/or a method of operation of the wrench assembly. It is appreciated that the order and/or sequence illustrated and described herein are not necessarily indicative of how the wrench assembly operates chronologically, as one or more of the steps can be combined, reordered, repeated and/or performed simultaneously without deviating from the intended breadth and scope of the wrench assembly and method. It further is recognized that the method described below is merely one representative example of how the wrench assembly can be utilzed and is not intended to be limiting in any manner. Additionally, it is also appreciated that the wrench assembly and the method recited herein can be used to make any necessary lash adjustments, e.g., coarse lash adjustments and/or fine lash adjustments.

At step 301, the socket of the wrench assembly can be positioned about the adjuster nut so as to enable rotation of the adjuster nut.

At step 303, the lash adjuster can be positoned to engage the adjuster screw so as to enable rotation of the adjuster screw.

At step 305, the adjuster nut is loosened, and the adjuster screw can be adjusted to zero lash (0.000), i.e. with no space between the particular mechanical components to be adjusted.

At step 307, the adjuster nut is then retightened to a specified torque setting. At step 309, the measurement scale can be indexed to zero utilizing the lash adjuster.

At step 311, the adjuster nut is again loosened, and the lash adjuster is rotated until the lash indicator indicates a desired lash specification on the measurement scale.

At step 313, the adjuster nut is then again retightened to the specified torque setting.

At step 315, the user can double check that the lash indicator is still indicating the desired lash specification.

It is understood that although a number of different embodiments of the wrench assembly 14 have been illustrated and described herein, one or more features of any one embodiment can be combined with one or more features of one or more of the other embodiments, provided that such combination satisfies the intent of the present invention.

While a number of exemplary aspects and embodiments of the wrench assembly 14 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A wrench assembly for use in adjusting relative position between a first mechanical component and a second mechanical component in a mechanical system, the wrench assembly comprising:
a lash adjuster including an adjuster axis, the lash adjuster being configured to selectively rotate about the adjuster axis to adjust the relative position between the first mechanical component and the second mechanical component;
a lash indicator; and
a measurement scale;
wherein a relative position between the lash indicator and the measurement scale provides a precise visual indication of the relative position between the first mechanical component and the second mechanical component.

2. The wrench assembly of claim 1 wherein one of the lash indicator and the measurement scale is fixedly secured to the lash adjuster such that rotation of the lash adjuster about the adjuster axis provides a corresponding rotation of the one of the lash indicator and the measurement scale about the adjuster axis; and wherein the other of the lash indicator and the measurement scale does not rotate about the adjuster axis correspondingly with the lash adjuster.

3. The wrench assembly of claim 2 wherein the lash indicator is fixedly secured to the lash adjuster and rotates about the adjuster axis correspondingly with the rotation of the lash adjuster.

4. The wrench assembly of claim 2 wherein the measurement scale is fixedly secured to the lash adjuster and rotates about the adjuster axis correspondingly with the rotation of the lash adjuster.

5. The wrench assembly of claim 1 wherein the lash indicator points at the measurement scale to provide the visual indication of the relative position between the first mechanical component and the second mechanical component.

6. The wrench assembly of claim 5 wherein the measurement scale includes a plurality of measurement markers that are incrementally spaced apart from one another on a face of the measurement scale.

7. The wrench assembly of claim 1 wherein the mechanical system includes an adjuster screw; and wherein the lash adjuster is configured to engage the adjuster screw and rotate the adjuster screw to adjust the relative position between the first mechanical component and the second mechanical component.

8. The wrench assembly of claim 7 wherein the adjuster screw has a thread pitch; wherein the first mechanical component is a rocker arm having a rocker ratio; and wherein the measurement scale is rotatable about the adjuster axis to calibrate the relationship between the lash indicator and the measurement scale based at least in part on the thread pitch of the adjuster screw and the rocker ratio of the rocker arm.

9. The wrench assembly of claim 7 further comprising a torque wrench head and a base member that is fixed secured to the torque wrench head; and wherein the base member is configured to center the lash adjuster for accurate engagement with the adjuster screw.

10. The wrench assembly of claim 7 wherein the mechanical system further includes an adjuster nut that is selectively rotatable relative to the adjuster screw; and wherein the wrench assembly further includes a socket that is selectively positionable about the adjuster nut, the socket including a socket axis, the socket being selectively rotatable about the socket axis to adjust the position of the adjuster nut relative to the adjuster screw to adjust a torque setting within the mechanical system.

11. A method for using a wrench assembly for adjusting relative position between a first mechanical component and a second mechanical component in a mechanical system, the method comprising:
selectively rotating a lash adjuster about an adjuster axis to adjust the relative position between the first mechanical component and the second mechanical component;
providing a lash indicator;
providing a measurement scale; and
fixedly securing one of the lash indicator and the measurement scale to the lash adjuster such that rotation of the lash adjuster about the adjuster axis provides a corresponding rotation of the one of the lash indicator and the measurement scale about the adjuster axis; and
wherein a relative position between the lash indicator and the measurement scale provides a precise visual indication of the relative position between the first mechanical component and the second mechanical component.

12. The method of claim 11 wherein the step of providing the lash indicator includes fixedly securing the lash indicator to the lash adjuster such that rotation of the lash adjuster about the adjuster axis provides a corresponding rotation of the lash indicator about the adjuster axis; and wherein the step of providing the measurement scale includes the measurement scale not rotating about the adjuster axis correspondingly with the lash adjuster.

13. The method of claim 11 wherein the step of providing the measurement scale includes fixedly securing the measurement scale to the lash adjuster such that rotation of the lash adjuster about the adjuster axis provides a corresponding rotation of the measurement scale about the adjuster axis; and wherein the step of providing the lash indicator includes the lash indicator not rotating about the adjuster axis correspondingly with the lash adjuster.

14. The method of claim 11 wherein the step of fixedly securing includes the lash indicator pointing at the measurement scale to provide the visual indication of the relative position between the first mechanical component and the second mechanical component.

15. The method of claim 14 wherein the step of providing the measurement scale includes the measurement scale having a plurality of measurement markers that are incrementally spaced apart from one another on a face of the measurement scale.

16. The method of claim 11 wherein the step of selectively rotating includes engaging an adjuster screw of the mechanical system with the lash adjuster, and rotating the adjuster screw to adjust the relative position between the first mechanical component and the second mechanical component.

17. The method of claim 16 wherein the step of selectively rotating includes the first mechanical component being a rocker arm with a rocker ratio; and wherein the step of providing the measurement scale includes rotating the measurement scale about the adjuster axis to calibrate the relationship between the lash indicator and the measurement scale based at least in part on a thread pitch of the adjuster screw and the rocker ratio of the rocker arm.

18. The method of claim 16 further comprising fixedly securing a base member to a torque wrench head of the wrench assembly; and centering the lash adjuster for accurate engagement with the adjuster screw with the base member.

19. The method of claim 16 further comprising selectively rotating a socket about a socket axis to adjust the position of an adjuster nut of the mechanical system relative to the adjuster screw to adjust a torque setting within the mechanical system.

20. The method of claim 19 wherein the step of selectively rotating the socket occurs prior to the step of selectively rotating the lash adjuster.
